(19) United States
(12) Patent Application Publication
(10) Pub. No.: US 2006/0070406 A1
(43) Pub. Date: Apr. 6, 2006

(54) Use of coal ash for the safe disposal of mineral waste

(75) Inventors: Alexander Raichel, Rishon LeZion (IL); Svetlana Raichel, Rishon LeZion (IL); Amir Nachumi, Ramat-HaSharon (IL)

Correspondence Address: Martin MOYNIHAN;c/o ANTHONY CASTORINA, SUITE 207, 2001 JEFFERSON DAVIS HIGHWAY, ARLINGTON, VA, 22202, US

(73) Assignee: Orgyr Technologies Ltd.

(21) Appl. No.: 10/950,589

(22) Filed: Sep. 28, 2004

(51) Int. Cl. C03B 5/16

(52) U.S. Cl. 65/134.8; 65/19

(57) ABSTRACT

A method for using coal ash for disposing of mineral waste, including toxic mineral waste, is disclosed including making a molten mixture of the mineral waste with the coal ash and solidifying the molten mixture to make a solid product such as a glass, a glass-ceramic or a marble-like glass.

### FIELD AND BACKGROUND OF THE INVENTION

The present invention relates to the field of waste disposal and specifically to a process employing coal ash as a vitrification agent for safely neutralizing and disposing of mineral wastes, especially toxic mineral wastes. The present invention also relates to the field of materials and specifically to a method of making glass, glass-ceramics and marble-like glasses from a combination of coal ash and mineral wastes. The present invention also relates to the use of scrubber waste as a fluxing agent in the production of glass.

Coal ash is a particulate waste that is substantially the incombustible residue left after the combustion of coal in coal-fired power plants, furnaces and other industrial facilities. Two types of coal ash are recovered: a coarse sand-like bottom ash recovered from the bottom of furnaces and talc-like fly ash of silt-sized or clay-sized particles. In a typical coal-burning installation about one ton of bottom ash is recovered for every five tons of fly ash recovered.

The amount of coal ash produced is generally between 5% and 13% of the weight of the unburned coal. The mineral composition of coal ash depends on the composition of the coal. Generally bottom ash and fly ash from the same source have substantially the same mineral content. However, whereas coal bottom ash is substantially carbon-free, coal fly ash has a significant unburned carbon content. Depending on the efficiency of the combustion process and the nature of the coal burned, the carbon content of coal fly ash is typically up to about 12% carbon by weight, although values of up to 25% carbon by weight are not uncommon.

In Table 1 the mineral composition of ashes formed by the incineration of different coals imported to Israel are shown. It is important to note that Table 1 shows the weight ratios of the mineral components of coal ash and not the weight percent including carbon.

TABLE 1
Mineral composition of coal ash resulting from combustion
of coal imported to Israel (1999/2000) (weight ratios)

| | U.S.A. | Indonesia | Poland | | | Republic of |
|---|---|---|---|---|---|---|
| | (consol bailey) | (kaltim prima) | (weglokoks) | Australia | Colombia | South Africa |
| SiO₂ | 50.3 | 54.4 | 41.8 | 50.2-70.9 | 59-62 | 38-54 |
| Fe₂O₃ | 15.1 | 8.6 | 11.2 | 4.0-11.7 | 7-8.5 | 2.8-5.5 |
| Al₂O₃ | 24.4 | 22.5 | 28.1 | 19-35.4 | 18-24.1 | 25.6-36 |
| TiO₂ | 1.1 | 0.9 | 1.1 | 0.8-1.4 | 0.9-1.2 | 1-2 |
| CaO | 2.9 | 3.2 | 3.8 | 0.6-3.5 | 2.2-3.0 | 3.5-14 |
| MgO | 0.7 | 3.2 | 2.6 | 0.5-1.7 | 1.3-1.9 | 0.7-2.5 |
| SO₃ | 1.6 | 3.5 | 3.4 | 0.2-3 | 1.4-2.4 | 1.2-4 |
| Na₂O | 0.6 | 1.0 | 1.2 | 0.2-0.5 | 0.5-0.7 | 0.2-0.5 |
| K₂O | 1.8 | 1.9 | 2.0 | 0.5-2.9 | 1.1-1.9 | 0.1-0.6 |
| P₂O₅ | 0.5 | 0.5 | 2.5 | 0.2-1.7 | 0.2 | 1.5-2.3 |

The disposal of coal bottom ash is not considered to be a major problem. Due to the large size of the particles and relatively small amounts produced, coal bottom ash is cheaply transported in open vehicles and used, for example, as a gravel substitute in applications including concrete manufacture, road paving, road beds and as an embankment filler.

In contrast, the disposal of coal fly ash is a major challenge. Coal fly ash is a fine particulate that spreads easily, polluting air, surface water and large areas of land as a dust. The transport of coal fly ash must be performed in sealed vehicles such as tankers. Landfill disposal is the most common method of coal fly ash disposal. As the price of landfill disposal becomes increasingly uneconomic, alternative methods for coal fly ash disposal are being implemented including as a replacement for Portland cement in the manufacture of concrete, as a structural fill instead of sand, in road construction, as a daily cover in landfills or in bricks as a substitute for clay.

Efforts have been made to find high added value uses for coal fly ash.

In U.S. Pat. No. 2,576,565, Brown teaches a sintered ceramic product made up of at least 80% by weight coal fly ash as a matrix trapping grog made up of coal bottom ash. The fly ash and bottom ash are mixed with water to form a moldable composition that is pressed into a shape. Subsequently the shaped composition is fired at about 900° C. so as to sinter the fly ash (but not the bottom ash) to yield a product that is useful as a construction material.

In Russian patent RU 2052400, Bajakin et al. teach a glass composition that is made of bottom ash. The addition of between 3% and 8% graphite by weight to molten bottom ash leads to the reduction of metal oxides to carbides during the vitrification process. The resulting glass, in addition to uses in the building industry, is useful in the field of magneto-optics.

In U.S. Pat. No. 6,342,461, Ki-Gang et al. teach a composition including between 15 and 45 weight parts coal fly ash, between 5 and 55 weight parts clay and between 5 and 75 weight parts solid waste material (e.g., electrical arc furnace dust, steel slag, paper ash, aluminum dross) that is pressed into a shape and fired at a temperature of between 900° C. and 1300° C. to sinter the composition, producing ceramic blocks useful in the construction industry.

Glass-ceramics and marble-like glasses are compositions containing a crystalline phase or phases embedded in an amorphous phase, which crystalline phase or phases are produced by cooling a molten glass composition to a temperature which causes a portion of the composition to crystallize while the remainder solidifies in an amorphous state. In glass-ceramics the crystalline phase or phases make up at least 50 percent by weight of the composition. In marble-like glasses (Marbelite) the crystalline phase or phases make up between about 15 percent and 50 percent by weight of the composition.

The physical properties of glass-ceramics, such as strength, hardness, heat resistance, inertness to chemical, oxidative and atmospheric attack, are superior to those of glass. The physical properties of marble-like glasses are intermediate between those of glass and glass-ceramics.

Glass-ceramics are fabricated from a glass precursor composition including a component that acts as a nucleation agent. The glass precursor composition is melted and cooked at a temperature typically above 1300° C. to form a homogenous molten glass composition. The glass is then maintained in a molten state for a period of time and in a temperature regime to allow devitrification, vide infra. During devitrification components of the composition crystallize around the nucleation agent. Ultimately produced are stochiometrically accurate crystal phases embedded in an amorphous phase.

Generally, the physical properties of glass-ceramics and marble-like glasses are dependent on a number of material properties. A first property is the identity of the crystal phase or phases. A second property is the ratio of crystalline phase to amorphous phase: generally, the higher the proportion of crystalline phase, the harder and less frangible is the product. A third property is crystal size. The smaller the crystals, the more difficult it is for cracks to spread throughout a glass-ceramic structure, making such a structure more robust. Generally, a crystal size smaller than 1 micron is known as being appropriate for most implementations.

The crystal size and crystal content in a glass-ceramic or marble-like glass are dependent on at least two parameters of the devitrification process: the rate of formation of nucleation centers (which occurs at a maximal rate at some temperature Tₘₐₓ₁) and the rate of crystal growth (which occurs at a maximal rate at some temperature Tₘₐₓ₂, where Tₘₐₓ₂>Tₘₐₓ₁). Ideally, once Tₘₐₓ₁ and Tₘₐₓ₂ are known, a crystallization regime can be formulated, see FIG. 1. On a practical level, however, it is difficult to accurately expose a glass to the theoretical Tₘₐₓ₁ and Tₘₐₓ₂ in a crystallization oven, a problem aggravated by the fact that the actual oven temperatures fluctuate depending on many conditions.

As a compromise, in the art it is known to use either a one-stage devitrification regime or a two-stage devitrification regime when producing a glass-ceramic or marble-like glass from a molten glass composition.

In a one-stage devitrification regime, the molten glass composition is maintained in an oven set at a single temperature midway between Tₘₐₓ₁ and Tₘₐₓ₂, the single temperature giving an acceptable compromise of properties.

In a two-stage devitrification regime, the molten glass composition is maintained in an oven set at a first temperature, the first temperature being roughly Tₘₐₓ₁. After a certain amount of time deemed sufficient for formation of enough nucleation centers, the temperature setting of the oven is raised to a second higher temperature, the second temperature being roughly Tₘₐₓ₂.

A glass-ceramic glass precursor composition generally includes between about 30% and 75% by weight SiO₂ and between about 7% and 35% by weight Al₂O₃ and an additional component that acts as a nucleation agent. Typical nucleation agents include CeO₂, Cr₂O₃, MnO2, P₂O₅, SnO₂, TiO₂, V₂O₅, ZnO and ZrO₂ as well as anions such as F—, S²⁻ and SO₄²⁻. Often fluxing agents are added to a glass precursor composition. Typical fluxing agents include CaO, K₂O, Na₂O, Li₂O, PbO, MgO, MnO and B₂O₃. Often fining agents are added to a glass precursor composition. Typical fining agents include As₂O₃ and Sb₂O₃. Other components typically found in glass-ceramic glass precursor compositions include Fe₂O₃, BaO, ZnO, Mn₃O₄, NiO, CoO and oxides of Ge, Ga, Se, Nb and Sb.

The lenient requirements of glass-ceramic glass precursor compositions allow the use of cheap and impure starting materials for the production of glass-ceramics. For example, a number of methods for disposing of coal ash by using the coal ash as a component of a glass-ceramic have been described in the art.

In U.K. Patent GB 1,459,178, Dostal teaches the use of coal fly ash for the production of glasses and glass-ceramics. Dostal teaches a glass-precursor composition including from about 10%, but preferably at least 50% and up to 90% coal fly ash. To achieve desired final-product properties, Dostal teaches the addition of various materials to the fly ash including sand, MgO (as MgCO₃ or MgO), CaO (as CaCO₃ or Ca(OH)₂), ZnO (as Zn), BaO (as Ba(NO₃)₂). In a first step before the addition of other components, Dostal teaches an ignition step whereby carbon is removed as CO₂.

In French Patent FR 2367027, Santt teaches the use of coal fly ash, “red waste” (iron rich materials), coal mining schist, zinc slag, lead slag, red mud from Al₂O₃ or TiO₂ production, each as a component of a glass-precursor composition that is used to make glass or glass ceramic products. Desired mineral ratios are obtained by the addition of sand, CaO, MgO, Na₂CO₃, blast furnace slag, sodium feldspar or phonolite. In one embodiment, 50% by weight fly ash is mixed with 30% CaO and 20% sodium feldspar to obtain a glass precursor composition.

In U.S. Pat. No. 5,935,885, Hnat et al. teach a glass-precursor composition including between 60% and 100% by weight fly ash (including fly ashes from coal burning, municipal solid waste incinerators and auto shredder residues) and between 0% and 40% by weight other additives such as limestone, gypsum, dolomite, silica, cullet, titania, zirconia and electric arc furnace dust. A critical step taught by Hnat et al. is the oxidation of organic materials and metallic contaminants that prevent the formation of a glass-ceramic of sufficient quality in a first step carried out at 1000° C. to 1500° C. by suspension oxidation.

In U.S. patent application Ser. No. 10/047,395, inventors of the present invention teach a method of disposing of coal ash by mixing the coal ash with a glass-forming agent (e.g., calcium carbonate, alumina or magnesium oxide) and a nucleation agent to make a glass-ceramic glass precursor composition. In all examples a step is taught where carbon in the fly ash is oxidized and removed as CO₂.

Despite all the uses recited above for coal ash, large amounts of coal ash remain unexploited. For example of the roughly 130 million tons of coal combustion products produced in the United States annually, only about one third is used while the rest, primarily coal fly ash, is deposited in landfills.

In addition to coal ash, modern society produces large amounts of different mineral wastes, including but not limited to, asbestos, auto shredder residue ash, batteries, contaminated soils, demolition waste, electric arc furnace dust, geological mine tailings (such as schist), hospital and health care waste, sewage sludge ash, municipal solid waste incinerator ash, paint waste, varnish waste, spent filter aids from water treatment plants and waste from metal and semiconductor industries (including slag, “red mud”, electroplating waste). Importantly, such mineral wastes are often toxic due to the relatively high concentrations of compounds and heavy metals such as asbestos, antimony, arsenic, barium, cadmium, chromium, cobalt, copper, lead, magnesium, manganese, mercury, molybdenum, nickel, osmium, phosphorous, selenium, silver, sulfur, thorium, tin, tungsten uranium, vanadium and zinc.

One characteristic of mineral wastes is the great variation in composition. For example, since municipal solid waste incinerator ash is the result of the incineration of municipal waste, trash and garbage, the composition of municipal solid waste incinerator ash is ill-defined and includes mineral components from many and varied sources including batteries, building materials, demolition waste, paints, photographic waste, asbestos, carpets, rubbers, bicycles, sewing machines, mechanical devices, electronic devices and inks. For example, since scrap metal waste is the result of smelting of metal and metallic waste from roadsides and scrap heaps. The composition of scrap metal waste is ill-defined, and depending on whether pure metals are recovered from the scrap or not, include a high percentage of zinc from galvanized waste, magnesium, iron and lead from discarded automobiles, a relatively high sulfur and halogen content from plastic and rubber parts, as well as many inorganic components from paints, vehicle coatings, vehicle fluids (e.g., molybdenum) and “exotic” metal scrap.

The safe disposal of toxic mineral waste is a significant challenge. The primary method of disposing of toxic waste is internment in ground fills. The disadvantages of toxic waste internment are well known and include the necessity of turning large land areas into toxic wastelands, dangerous work conditions in the internment sites, leakage of toxic waste into the ground, eventual aquifer contamination and the cost and danger involved in transporting the waste to the remote location. Further, it is known that ultimately population centers grow to proximity with the waste internment sites, leading to a demand to relocate the waste and contaminated soil to new and even more remote internment locations. It is recognized that it is preferable to permanently neutralize toxic mineral waste.

One approach known in the art for neutralizing toxic mineral waste is to produce a material including a matrix wherein toxic components of the mineral waste are trapped. In some cases the produced material is fashioned into a useful product. In other cases the produced material is buried.

In U.S. Pat. No. 5,008,503, Hashimoto et al. teach a method of combining sewage sludge ashes with clay, fine powders of water-granulated aggregates, river sand, wall-tile dust, feldspar and firing the combined product at 1100° C. to make a sintered product suitable as a road paving material.

In U.S. Pat. No. 4,112,033, Lingl teaches a brick made by firing a mixture of between 30% and 50% by weight sewage sludge with clay at about 1100° C. to produce a sintered product entrapping toxic components of the sludge.

In U.S. Pat. No. 5,175,134, Kaneko et al. teach a method of neutralizing sludge by combining solidified molten ash of incinerated sludge slag with agalmatolite and clay and firing the combination to produce a sintered tile.

In U.S. Pat. No. 4,120,735, Smith teaches a sintered product made of a composition of municipal waste incinerator ash, coal fly ash and a binder (e.g., sodium silicate) fired at up to about 1230° C. Similarly, in U.S. Pat. No. 4,977,837, Roos et al. teach a sintered product made of a composition of municipal waste incinerator fly ash, and a vitrification agent such as cullet or clay fired at up to about 1180° C.

In U.S. Pat. No. 4,911,757, Lynn et al. teach entrapment of heavy metals in a concrete-like material based on coal fly ash and other components.

In U.S. Pat. No. 4,988,376, Mason et al. teach the sintering of silica-rich soil contaminated with heavy metals such as lead in the presence of a fluxing agent (e.g., trona, barium oxide, calcium oxide, lithium oxide) up to about 1200° C. In cases where the soil has insufficient silica, cullet or quartz is added. Some metals (e.g., lead, gold, silver, platinum) separate from the glass by the addition of reduction agent (e.g., wheat flour, charcoal, sulfur) and are recovered.

The above and other methods lead to the trapping of the toxic waste substantially unchanged in a sintered matrix so the danger of exposure to the toxic waste remains.

In the art, a preferred method for trapping toxic waste is by complete vitrification, as opposed to trapping in a sintered material as described above. In a vitrification process, the toxic components are homogenously mixed inside a water-impermeable glass. Unfortunately, the chemical composition of most industrial toxic waste is such that vitrification is not a matter of simply heating the waste to an appropriate temperature. Often the waste decomposes before the vitrification temperature is reached or the vitrification temperature is so high that the process becomes uneconomical. As a result most waste vitrification processes require the addition of relatively expensive vitrification agents, for example, alumina, concrete, dolomite, limestone, phonolite and sand.

In U.S. Pat. No. 4,666,490, Drake teaches neutralization of an aqueous stream (e.g., an electroplating waste liquid) including toxic mineral contaminants by heating the stream to remove water and subsequently to convert compounds therein to inorganic oxides in a melt of glass frit at temperatures of up to 1400° C. to ensure complete vitrification while vaporizing volatile components and then cooling the melt to form a glass entrapping the non-volatile toxic components.

In U.S. Pat. No. 2,217,808, Nye teaches a method for converting furnace slag into a glass-like composition by adding silica to molten slag emerging from a furnace at a temperature of about 1400° C.-1500° C.

A problem that often occurs when processing mineral waste occurs when the waste contains a high percentage of gas-forming components such as halides (fluorides, chlorides, bromides, iodides), sulfur compounds and phosphorous compounds that are only slightly soluble in the molten glass compositions. During the processing of such wastes by vitrification, large volumes of toxic, corrosive and environmentally unfriendly exhaust gas, such as HCl, Cl₂, HBr, Br₂, SO₂ and SO₃ are produced. The production of the gases necessitates the release of these gases into the environment (defeating the raison d'être of the process) or installation of expensive scrubber systems that produce a new toxic mineral waste. Further, the formation of these gases creates a difficult to handle, hot, corrosive, toxic foam that presents a significant workplace safety hazard.

In U.S. Pat. No. 5,035,735, Pieper et al. disclose a process for vitrification of wastes having a high content of gas-forming components (such as asbestos, construction and demolition material, sewage sludge, varnish sludge, ashes and filter dust) by forming a gall layer floating on a molten glass layer to absorb a large proportion of released gases. Vitrification and gall layer formation is achieved by the addition of materials such as CaSO₄, CaCl₂, MgSO₄, MgCl₂, phonolite, silica sand or cullet to the waste.

In PCT patent application PCT/CS92/00025 published as WO 93/05894, Vlĉek et al. teach a method of vitrification of dusty waste, such as sulfur-rich incinerator fly ash with iron containing amber glass cullet. The iron in the cullet reduces sulfur anions to sulfur, preventing formation of a sulfate foam.

As discussed above, toxic mineral waste is often vitrified for long-term disposal. Vitrification of toxic waste involves mixing the toxic waste with a glass-forming material so as to produce a vitrifiable mixture. In most cases, it is required that a sufficient amount of a glass-forming material be added to the waste so that complete entrapment of the toxic minerals occurs. A “sufficient amount” of glass-forming material is dependent on the composition of the waste. In some cases, where the toxic components are not very soluble in the glass, a “sufficient amount” is very high. The mixture is melted and upon cooling, solidifies to form a glass. Glass is water-insoluble and, as such, is a suitable matrix for trapping toxic wastes. However, it is known that metals leach out of glasses. Further, glasses are frangible, soft, and neither erosion-resistant nor wear-resistant, facts that raise concerns for the long-term safety of toxic waste stored in a glass. Such safety concerns are multiplied because vitrified toxic waste is substantially a contaminated glass, increasing frangibility and making such glass less wear resistant than other glasses.

It would be advantageous to have a method for disposing of mineral wastes such as coal ash and toxic wastes devoid of the disadvantages of the methods known in the art. Specifically, it is desired to have a method for safely disposing of coal fly ash for burial or to use coal ash to make high added value products. It is desired to have a safe method for the long-term disposal of mineral wastes that overcomes problems associated with gas-forming components of the mineral waste, yet does not use expensive vitrification additives. It is preferred that such a method trap toxic components more safely than is achievable with glass.

### SUMMARY OF THE INVENTION

At least some of the objectives above are achieved by the teachings of the present invention.

The teachings of the present invention provide for the disposal of mineral waste and coal ash by vitrification of the mineral waste together with the coal ash to produce a solid material. In preferred embodiments, in a devitrification step a glass-ceramic or a marble-like glass material is obtained.

According to the teachings of the present invention there is provided a method for using coal ash comprising: a) providing a molten glass composition including a first amount of coal ash and a second amount of mineral waste; b) maintaining the molten glass composition in a molten state for a period of time so as to reduce components of the glass-precursor composition; and c) solidifying the molten glass composition so as to obtain a solid material.

In an embodiment of the present invention, providing the molten glass composition includes: i) mixing the coal ash with the mineral waste to obtain a glass-precursor composition; and ii) melting the glass-precursor composition to obtain the molten glass composition.

In an embodiment of the present invention, the molten glass composition includes a reducing agent, preferably carbon. In an embodiment of the present invention, the reducing agent is a carbon component of the mineral waste. In an embodiment of the present invention, the reducing agent is a carbon component of the coal ash.

The coal ash comprises coal fly ash, coal bottom ash, or a combination of both. In an embodiment of the present invention, the carbon component of the coal ash is greater than about 0.5%, greater than about 1%, greater than about 5% or even greater than about 10% by weight of the coal ash.

In an embodiment of the present invention, the coal ash comprises between about 30% and about 75%, or between about 40% and about 71%, by carbonless weight SiO₂.

In an embodiment of the present invention, the coal ash comprises between about 10% and about 40%, or between about 15% and about 35%, by carbonless weight Al₂O₃.

In an embodiment of the present invention, the coal ash comprises between about 2% and about 20%, or between about 3% and about 16%, by carbonless weight Fe₂O₃.

In an embodiment of the present invention, the mineral waste comprises a waste selected from the group of wastes consisting of aluminum dross, asbestos, auto shredder residue, batteries, blast furnace slag, cement waste, coal mine schist, contaminated soils, demolition waste, electric arc furnace dust, electroplating waste, flue gas desulfurization waste, geological mine tailings, heavy metal waste, health care incinerator waste, incinerator ash, inorganic filter media, ion-exchange resins, lead slag, municipal waste incinerator residue, paint waste, paper ash, photographic waste, red waste, rubber waste, scrubber waste, sewage sludge ash, scrap metal waste, sludge solids, solid residue of aqueous waste streams, spent filter aids, steel slag, tile dust, urban waste, varnish sludge, zeolites, zinc slag and mixtures thereof.

In an embodiment of the present invention, the mineral waste is substantially a waste selected from the group of wastes consisting of aluminum dross, asbestos, auto shredder residue, batteries, blast furnace slag, cement waste, coal mine schist, contaminated soils, demolition waste, electric arc furnace dust, electroplating waste, flue gas desulfurization waste, geological mine tailings, heavy metal waste, health care incinerator waste, incinerator ash, inorganic filter media, ion-exchange resins, lead slag, municipal waste incinerator residue, paint waste, paper ash, photographic waste, red waste, rubber waste, scrubber waste, sewage sludge ash, scrap metal waste, sludge solids, solid residue of aqueous waste streams, spent filter aids, steel slag, tile dust, urban waste, varnish sludge, zeolites, zinc slag and mixtures thereof.

In an embodiment of the present invention, the mineral waste comprises more than about 2%, 4%, 6%, 10% or even 20% by weight gas-forming components (such as components including at least one phosphorous, sulfur or halogen atom)

In an embodiment of the present invention, the first amount is more than about 30%, more than about 50%, more than about 80%, more than about 100% or even more than about 150% by weight of the second amount.

In an embodiment of the present invention, a fluxing agent is added to obtain the glass precursor composition. Preferably the fluxing agent is a waste material, such as scrubber waste.

In an embodiment of the present invention, during the period of time when the molten glass composition is maintained in a molten state, the temperature of the molten glass composition is higher than about 1200° C., higher than about 1250° C., higher than about 1300° C. or even higher than about 1350° C. In an embodiment of the present invention, during the period of time when the molten glass composition is maintained in a molten state, the temperature of the molten glass composition is lower than about 1600° C. or even higher than about 1500° C. In an embodiment of the present invention the period of time during which the molten glass composition is maintained in a molten state is longer than about 1 hour, longer than about 2 hours or even longer than about 3 hours.

In an embodiment of the present invention, solidifying the molten glass composition includes cooling the molten glass composition so that the solid material obtained is a glass. In an embodiment of the present invention, the glass is cast, rolled, blown, pressed or drawn.

In an embodiment of the present invention, solidifying the molten glass composition includes devitrifying the molten glass composition. Preferably, devitrification includes maintaining the molten glass composition in a molten state for a period of time sufficient to allow crystallization of at least some of the molten glass composition. In an embodiment of the present invention, solidifying the molten glass composition includes devitrifying the molten glass composition so that the solid material obtained is a marble-like glass. In an embodiment of the present invention, solidifying the molten glass composition includes devitrifying the molten glass composition so that the solid material obtained is a glass-ceramic.

According to the teachings of the present invention there is also provided a solid material, substantially produced according to the method of the present invention.

According to the teachings of the present invention there is also provided an article, the article comprising a solid material made according to the method of the present invention. In embodiments of the present invention the solid material is a glass, a glass-ceramic or a marble-like glass.

According to the teachings of the present invention there is also provided for the use of scrubber waste as a fluxing agent.

According to the teachings of the present invention there is also provided for the use of scrubber waste as a fluxing agent in the production of glass.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 (prior art) is a graph showing the relationship between temperature and the nucleation center formation rate (dashed) and the crystallization rate (solid).

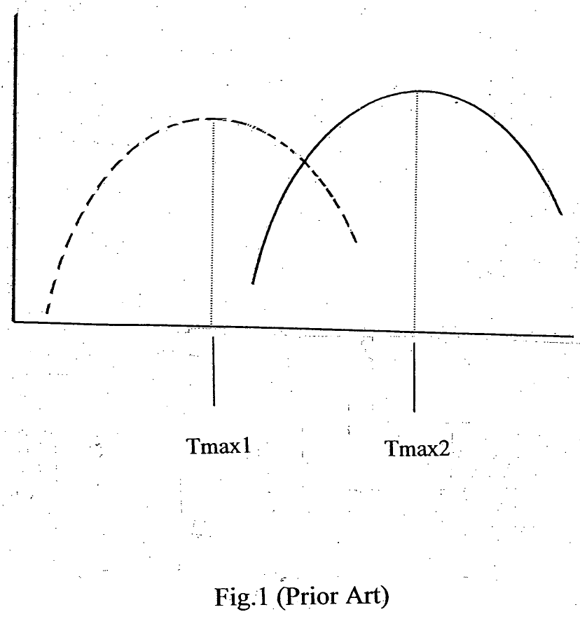

### DESCRIPTION OF THE PREFERRED EMBODIMENTS

The present invention is of a method for using coal ash for disposing of mineral waste by vitrification of a mixture of mineral waste and coal ash under reducing conditions. In preferred embodiments of the present invention, carbon in coal ash is used to reduce components of the waste, especially gas-forming components, thus preventing the formation of dangerous gases. Thus, the teachings of the present invention provide a method for disposing of mineral waste that is simpler, cheaper and safer than methods known in the art.

In many embodiments of the present invention, the produced glass has been found to be suitable for devitrification to produce glass-ceramics and marble-like glasses. Devitrification leads to entrapment of some, if not all, toxic components inside crystalline phases, entrapment that is recognized as being superior to other forms of entrapment. Further, the improved physical properties and esthetic appeal of glass-ceramics and marble-like glasses produced in some embodiments of the present invention allow for either safer long-range internment or for the manufacture of high added-value products.

The present invention is also of a method for using scrubber waste as a fluxing agent in the production of glass.

The principles and uses of the teachings of the present invention may be better understood with reference to the accompanying description and the figure. Upon perusal of the description and figure presented herein, one skilled in the art is able to implement the teachings of the present invention without undue effort or experimentation.

Before explaining at least one embodiment of the invention in detail, it is to be understood that the invention is not limited in its application to the details set forth herein. The invention can be implemented with other embodiments and can be practiced or carried out in various ways. It is also understood that the phraseology and terminology employed herein is for descriptive purpose and should not be regarded as limiting.

Generally, the nomenclature used herein and the laboratory procedures utilized in the present invention include techniques from the fields of chemistry and engineering. Such techniques are thoroughly explained in the literature. Unless otherwise defined, all technical and scientific terms used herein have the same meaning as commonly understood by one of ordinary skill in the art to which the invention belongs. In addition, the descriptions, materials, methods and examples are illustrative only and not intended to be limiting. Methods and materials similar or equivalent to those described herein can be used in the practice or testing of the present invention. All publications, patent applications, patents and other references mentioned are incorporated by reference in their entirety as if fully set forth herein. In case of conflict, the specification herein, including definitions, will control.

As used herein, the terms “comprising” and “including” or grammatical variants thereof are to be taken as specifying the stated features, integers, steps or components but do not preclude the addition of one or more additional features, integers, steps, components or groups thereof. This term encompasses the terms “consisting of” and “consisting essentially of”.

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed composition, device or method.

The term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts. Implementation of the methods of the present invention involves performing or completing selected tasks or steps manually, automatically, or a combination thereof.

The present invention involves the use of two waste materials, coal ash and mineral waste, to produce a solid material that is safe for internment or, preferably, for use in producing high-added value products.

Herein, the term “mineral waste” is understood to mean a waste composition having less than about 70% or 60% or 50% or 40% or 30% by weight organic components. Often, a mineral waste is a product of incineration of a non-mineral waste.

A step of the method of the present invention includes providing a molten glass composition including a first amount of a coal ash and a second amount of a mineral waste. The molten glass composition is maintained in a molten state for a period of time so as to allow reduction of components of the glass-precursor composition. Ultimately, the molten glass composition is solidified to obtain a solid material.

The molten glass composition is provided is any one of many different ways. For example, in an embodiment of the present invention either the mineral waste or the coal ash is first melted and thereafter the other is added. In another embodiment of the present invention, a certain amount of one is mixed and melted together with an amount of the other and subsequently more of both is added until a molten glass composition is provided made up of the first amount of the coal ash and the second amount of the mineral waste.

A preferred embodiment and currently known best mode of providing a molten glass composition of the present invention includes mixing the coal ash (preferably the first amount) with the mineral waste (preferably the second amount) to obtain a glass-precursor composition and subsequently melting the glass-precursor composition to obtain the molten glass composition.

Subsequently, the molten glass composition is maintained in the molten state at a certain “cooking” temperature (generally higher than about 1200° C., higher than about 1250° C., higher than about 1300° C. or even higher than about 1350° C., but generally less than about 1600° C. and more preferably less than about 1500° C.) for a period of time (generally longer than 1 hour, longer than 2 hours, or even longer than 3 hours) during which complete vitrification of the glass composition is ensured, volatile components are released from the glass composition and components of the molten glass composition are reduced.

Generally, for components of the glass composition to be reduced, the molten glass composition includes a reducing agent, most preferably carbon. Herein, the term “reducing agent” is understood to mean an agent capable of reducing sulfur oxides (such as SO₄ and/or SO₃), and/or phosphorous oxides and/or one or more halogens under the conditions present in the molten glass composition.

In an embodiment of the present invention, the source of carbon is the carbon component of the mineral waste. However, in the currently known best mode of implementing the teachings of the present invention, the source of carbon is the coal ash, vide infra.

An object of embodiments of the present invention is to safely trap toxic components of the mineral waste. As the teachings of the present invention are intended to be generally useful, there are few, if any, limitations as to the nature and identity of the mineral waste. It is generally preferable to remove the water from waste having high water content so as to avoid the formation of large volumes of steam. Preferably, the mineral waste used in providing a molten glass composition comprises or is substantially mineral waste, including but not limited to aluminum dross, asbestos, auto shredder residue, batteries, blast furnace slag, cement waste, coal mine schist, contaminated soils, demolition waste, electric arc furnace dust, electroplating waste, flue gas desulfurization waste, geological mine tailings, heavy metal waste, health care incinerator waste, incinerator ash, inorganic filter media, ion-exchange resins, lead slag, municipal waste incinerator residue, paint waste, paper ash, photographic waste, red waste, rubber waste, scrubber waste, sewage sludge ash, scrap metal waste, sludge solids, solid residue of aqueous waste streams, spent filter aids, steel slag, tile dust, urban waste, varnish sludge, zeolites, zinc slag and mixtures thereof.

An advantage of the present invention is that volatile forms of gas-forming components (e.g., components including phosphorous, sulfur and halogens) are reduced to non-volatile forms that become entrapped in or part of the solid material produced according to the method of the present invention. Thus, compared to methods known in the art, the present invention reduces the amount of toxic exhaust by reducing gas-forming components to a form that remains entrapped in the produced solid material. In embodiments of the present invention, the mineral waste comprises more than about 2%, more than about 4%, more than about 6%, more than about 10% and even more than 20% by weight gas-forming components, especially phosphorous, sulfur and halogens. In this context, by weight percent of gas-forming components is meant the weight lost by the mineral waste subsequent to heating at 1500° C. in the presence of oxygen for a period of time sufficient for stabilization of the weight.

The primary purpose of the coal ash used in providing the molten glass composition of the present invention is as a vitrification agent for vitrifying the mineral waste. The advantages of coal ash as a vitrification agent for mineral waste are manifold and includes that the composition of coal ash is such that many different mineral wastes are effectively vitrified using the coal ash. Further, it has been found that coal ash has the appropriate composition to enable efficient devitrification when it is desired to produce a glass-ceramic or marble-like glass. Further, various coal ashes have differing compositions (see, for example, Table 1) so as to allow tailoring of a specific ash or ash combination to allow most efficient vitrification of a given mineral waste or to produce a solid material having desired properties. No less important is the fact that that coal ash is cheap (being a waste product available in practically limitless quantities) allowing the use of substantially any amount of coal ash to vitrify a given amount of a mineral waste.

As is seen in Table 1, although there are significant differences in the different ash compositions all have similarly high silica and alumina content, as well as a significant iron and alkaline earth content. These properties render coal ash a suitable vitrifying agent for the disposal of mineral waste.

Preferably, a coal ash suitable for implementing the teachings of the present invention comprises between about 30% and about 75% by carbonless weight SiO₂, or even between about 40% and about 71% by carbonless weight SiO₂.

Preferably, a coal ash suitable for implementing the teachings of the present invention comprises between about 10% and about 40% by carbonless weight Al₂O₃, or even between about 15% and about 35% by carbonless weight Al₂O₃.

Preferably, a coal ash suitable for implementing the teachings of the present invention comprises between about 2% and about 20% by carbonless weight Fe₂O₃, or even between about 3% and about 16% by carbonless weight Fe₂O₃.

Generally, fly ash, bottom ash or a combination of both are useful in implementing the teachings of the present invention. That said, as noted hereinabove, it is preferred that a molten glass composition of the present invention include a reducing agent, especially carbon. Since coal fly ash is naturally rich in carbon, in a preferred method of the present invention the coal ash used is coal fly ash or a mixture of coal fly ash and bottom ash that has sufficient carbon content. “Sufficient carbon content” is a functional term as is discussed hereinbelow. That said, according to the teachings of the present invention, the carbon component of the coal ash is greater than about 0.5% by weight, greater than about 1% by weight, greater than about 5% and even greater than about 10% by weight of the coal ash.

In a preferred embodiment, the exact composition of coal ash used as well as the ratio of the first amount (coal ash used) and second amount (mineral waste used) are chosen so as to ensure minimal escape of toxic components as volatile emissions during the melting and glass-cook steps of the method of the present invention and to select the properties of the produced material. It has been found that it is generally preferably, prior to processing a batch of a mineral waste, to first perform a number of small-scale experiments with varying ratios of the first amount of coal ash to the second amount of mineral waste until an acceptable result is achieved. Such preliminary experiments are not considered undue experimentation as the necessity for the preliminary experiments arises from the fact that both the composition of the coal ash and the composition of the mineral waste are generally ill-defined and change on a regular basis, and determination of the exact compositions is a time-consuming and expensive task.

It has been found that although any amount of coal ash is potentially sufficient for providing acceptable results, it is preferable that the first amount is more than about 30% by weight, more than about 50% by weight, more than about 80% by weight, more than about 100% by weight or more than about 150% by weight of the second amount, depending on the composition of the coal ash, the carbon content of the coal ash and the composition of the mineral waste.

In an embodiment of the present invention, solidifying the molten glass composition includes cooling the molten mixture so that the solid material obtained is a glass. The glass is then processed according to methods known in the art including such methods as casting, rolling, blowing, pressing and drawing.

In a preferred embodiment of the present invention, solidifying the molten glass composition includes devitrification of the molten glass composition.

Devitrification generally includes maintaining the molten glass composition in a molten state for a period of time sufficient to allow crystallization of at least some of the molten glass composition or first producing a solid glass and then re-melting the solid glass for devitrification. Devitrification of a molten glass composition of the present invention is generally performed using either a one-stage or two-stage temperature regime. In embodiments of the present invention, devitrification is performed to obtain a marble-like glass. It has been found that marble-like glasses made in accordance with the teachings of the present invention are exceptionally esthetic, thus suitable for use as alternatives for marble. In embodiments of the present invention, devitrification is performed to obtain a glass-ceramic.

One particular common and difficult to process toxic waste includes discarded batteries. Discarded batteries are considered so toxic as to warrant separation from other forms of household waste and separate internment as toxic waste. The whole process of handling batteries including gathering from households, separate transport, expensive internment and expensive public education efforts to convince consumers to separate batteries indicate the high-level of toxicity attributed to batteries. In a preferred embodiment of the present invention, batteries are provided as a mineral waste component of a glass-precursor composition of the present invention. The batteries are added to the coal ash either whole or not whole, e.g. ground-up.

Fluxing agents are important components in the manufacture of glass and related products. The addition of a fluxing agent to a glass precursor composition significant lowers the melting temperature, reducing the energy requirements, and subsequently cost, of glass production. Further, fluxing agents reduce the viscosity of a molten glass composition, allowing for simpler handling of the molten glass. Known fluxing agents include CaO, K₂O, Na₂O, Li₂O, PbO, MgO, MnO and B₂O₃. In embodiments of the present invention, a fluxing agent is added to a glass precursor composition.

Clearly, a disadvantage of adding a fluxing agent is the additional price involved in providing the fluxing agent itself. Therefore, in a preferred embodiment of the present invention, a fluxing agent added to a glass precursor composition is a waste material, especially a mineral waste, for example scrubber waste.

Scrubbers are substantially devices used to reduce the level of toxic fumes, such as sulfur-oxide fumes, released into the atmosphere by various industries such as coal-burning electrical power plants. Certain types of scrubbers use inorganic alkaline compounds such as CaO, CaCO₃, NaOH, Mg(OH)₂ or Ca(OH)₂ to react with exhaust gases such as SO₂ before release into the atmosphere. One preferred type of scrubber is the wet scrubber flue gas desulfurization (FGD) system. FGD systems introduce the inorganic alkaline compound into the flue as an aqueous spray. For example, when the inorganic alkaline compound is CaO, the CaO reacts with the exhaust gas and settles as an aqueous sludge of calcium sulfite (CaSO₃) or calcium sulfate (CaSO₄). Often FGD sludge includes a significant percentage of coal fly ash. Disposal of FGD sludge is a major environmental challenge and usually includes oxidation of the difficult to handle calcium sulfite to calcium sulfate.

Scrubber waste, including FGD sludge is an exceptionally suitable type of waste for processing according to the teachings of the present invention. The FGD sludge is added to the coal ash and the sulfur-containing components reduced to yield elemental sulfur and CaO, the CaO acting as a fluxing agent in the molten glass composition. In some embodiments of the present invention, the coal fly ash content and subsequently carbon content of the FGD sludge is such that the FGD sludge is the source of both the coal ash and the mineral waste components of the molten glass composition.

Another aspect of the present invention is the use of scrubber waste as a fluxing agent in production of glass, glass-ceramics, marble-like glasses and the like. In the general, when the scrubber waste is primarily CaO, CaCO₃ or the like, the scrubber waste is directly added as a fluxing agent. Volatile impurities are expelled and toxic impurities remain entrapped in the solid material ultimately formed. When the scrubber waste includes a significant proportion of compounds such as CaSO₃ or CaSO₄, a first reduction step is performed so as to yield the desired fluxing agent.

The primary advantage of the use of scrubber waste as a fluxing agent according to the teachings of the present invention is the replacement of relatively expensive pure fluxing agents with a waste material.

The teachings of the present invention are characterized by the production of a solid material from coal ash and mineral waste. The teachings of the present invention are generally useful and applicable to virtually any type of mineral waste.

In the field of waste disposal, the present invention allows for the use of a sufficient amount of cheap coal ash as a vitrification agent for safely entrapping toxic mineral waste. As discussed in the introduction, it is known in the art to combine mineral waste with a glass precursor to make a glass precursor mixture that is subsequently vitrified. For example U.S. Pat. No. 4,820,328 teaches the use of cullet and caustic soda as a vitrification agent. Known vitrification agents are generally expensive, and certainly more expensive than coal ash. The fact that the vitrification agent of the present invention is an abundant waste material has an additional, psychological, advantage that is translated into an important commercial advantage. For some mineral wastes it is necessary to add a relatively high proportion of vitrification agent. As prior art vitrification agents are expensive, unscrupulous operators may tend to scrimp with the vitrification agent, producing a potentially toxic glass product thought to be non-toxic. In contrast, since the vitrification agent used in implementing the teachings of the present invention is a waste product, there is no motivation for such unscrupulous conduct.

In embodiments of the present invention, the material produced is not a glass but a glass ceramic or marble-like glass. Since oxides of many heavy metals act as nucleation agents (e.g., CeO₂, Cr₂O₃, MnO₂, P₂O₅, SnO₂, TiO₂, V₂O₅, ZnO and ZrO₂) subsequent to devitrification a relatively large proportion of toxic components of the mineral waste become an integral part of a crystal and as such substantially impervious to leaching. Toxic components are more effectively neutralized by entrapment in a devitrified material than in a glass and so crystalline materials such as glass-ceramics and marble-like glasses of the present invention are preferred for long-term toxic waste internment. Due to superior physical characteristics and improved toxic waste neutralization properties, glass-ceramics produced in accordance with the teachings of the present invention are useful for producing high added-value consumer items and not just for internment. Exceptionally preferred is the use of such glass-ceramics in the construction of roads and concrete structures (as a gravel substitute) and as a construction item, for example as a facing material (as a marble substitute) or as a tile.

The teachings of the present invention are also characterized by increased safety. The reduction, and even prevention, of the formation of hot, toxic, corrosive gases and foams reduces dangers for workers implementing the teachings of the present invention.

The teachings of the present invention are also characterized by being cheap and economical, a fact that follows from the use of cheap waste products as substrates. In preferred embodiments, even fluxing agents, useful in lowering the vitrification temperature of the glass precursor composition of the present invention and thus reducing energy costs, are a waste product. Further, the fact that components of the glass composition are reduced, leads to a minimization of additional waste products produced by the method of the present invention. Since the production of toxic gases is reduced, the amount of scrubber waste produced (or toxic gases released into the atmosphere) when practicing the teachings of the present invention is significantly lowered.

Since coal fly ash is a fine, talc-like, powder, transport of coal fly ash is preferably done in a sealed container, a factor that increases the cost of disposing of the coal fly ash. In a preferred embodiment, the teachings of the present invention are practiced in the proximity of a source of coal fly ash, such as a coal-burning power plant. Since the coal fly ash is available without need for transport and since the energy necessary for vitrifying the glass-precursor composition of the present invention is nearby, it is only necessary to transport the mineral waste substrate. Practice of the teachings of the present invention in the proximity of a source of coal fly ash reduces costs and increases safety of the inherently cheap and safe method of the present invention even further.

The present invention is also characterized by exceptional environmental friendliness. The present invention recycles waste, including toxic waste, into safe and useful forms. The present invention has relatively modest energy requirements when using suitable waste products as fluxing agents. The present invention reduces emissions of toxic and pollutant gases.

As discussed hereinabove, the method of the present invention leads to the production of a solid material, generally a glass, a marble-like glass or a glass-ceramic. In embodiments of the present invention, the solid material produced is interred. In preferred embodiments of the present invention, the solid material produced is used to fashion many different useful products, including but not limited to tiles, floor tiles, facing materials, plates, construction materials and gravel substitute material for use, for example, in road construction, road beds and landfills.

### EXAMPLES

Reference is now made to the following example that, together with the above description, illustrate the invention in a non-limiting fashion

### Materials

Two different coal fly ashes were obtained from the Rutenberg Power Plant (Ashkelon, Israel).

A first coal fly ash resulting from combustion of coal from the Republic of South Africa had a mineral composition of SiO₂ (38-44 parts by weight), Fe₂O₃ (4.5-5.5 parts by weight), Al₂O₃ (32-36 parts by weight), TiO₂ (1.0-1.5 parts by weight), CaO (10-14 parts by weight), MgO (1.8-2.5 parts by weight), SO₃ (2.0-4.0 parts by weight), Na₂O (0.3-0.5 parts by weight), and K₂O (0.1-0.5 parts by weight) and approximately 13% by weight carbon. Vitrification of the ash at 1500° C. for 2 hours lead to resulted in the loss of approximately 30% of the weight of the ash.

A second coal fly ash resulting from combustion of Australian coal had a mineral composition of SiO₂ (60-62 parts by weight), Fe₂O₃ (8.0-9.0 parts by weight), Al₂O₃ (19-20 parts by weight), TiO₂ (0.8-1.5 parts by weight), CaO (2.5-3.5 parts by weight), MgO (1.0-1.7 parts by weight), SO₃ (2.0-3.0 parts by weight), Na₂O (0.3-0.5 parts by weight) and K₂O (1.5-2.0 parts by weight) and approximately 10% by weight carbon. Vitrification of the ash at 1500° C. for 2 hours lead to resulted in the loss of approximately 25% of the weight of the ash.

Disposal of Toxic Industrial Waste

A waste management company supplied a powdered toxic industrial waste. The toxic waste was from a combination of many sources but the waybill accompanying the waste indicated that the waste was composed of up to 50% Al₂O₃, up to 35% S, up to 7% SiO₂, up to 4% CdO, up to 2% NiO, up to 1% Cr₂O₃, up to 2% Br and up to 4% Cl. Vitrification of the ash at 1500° C. for 2 hours resulted in the loss of approximately 40% of the weight of the ash.

Ten different glass precursor mixtures were made by mixing the toxic industrial waste with the first coal fly ash in ratios (waste/ash) of 34:66, 33:67, 32:68, 31:69, 30:70, 29:71, 28:72, 27:73, 26:74 and 25:75.

1 kg of each one of the ten glass precursor mixtures was melted to form a molten glass composition and heated to a temperature of between 1450° C. and 1550° C. for about four hours in a Nabertherm HT 12/17 Chamber Furnace (Nabertherm GmbH, Bremen Germany).

Each mixture was cast as a 20 cm×20 cm plate and devitrified in a two-stage regime. To form nucleation centers, the mixture was cooled at a rate of 60° C./h to and maintained for two hours at a temperature of 800° C. Subsequently, the mixture was heated at a rate of 60° C./h to and maintained for two hours at a temperature of 1100° C.

The resulting glass-ceramic plates had a thin dispersed pattern of light brown and dark brown structures. All glass-ceramic plates had a dense and tightly packed crystalline phase. The plate including only 25% toxic waste had crystals of approximately 1 micron in size and had mechanical properties and an attractive appearance suitable for use as a flooring tile. The plates including higher percentages of toxic waste were found to have crystals approximately 10 microns in size. All plates were crystalline and as such suitable for safe burial of the toxic waste.

Importantly, the total weight-loss of the 34:66 glass precursor mixture to form the glass-ceramic was only approximately 9% of the total combined weight, indicating that gas-forming compounds such as halogens, sulfur compounds and phosphorous compounds were reduced and not released into the atmosphere. Further, it is assumed that at least some metals were reduced to carbides.

Disposal of Waste from Metal Scrap

Yehuda Pladot (Ashdod, Israel) supplied three types of powdered toxic mineral waste. The first type of toxic mineral waste was the product of smelted scrap metal. The waybill of the scrap metal waste indicated a composition of 0.75-0.90% Al₂O₃, 0.06-0.10% BaO, 5.90-7.40% CaO, 0.25-0.30% CuO, 18.3-21.7% Fe₂O₃, 1.25-1.55% K₂O, 1.0-1.7% MgO, 1.8-2.4% MnO, 1.4-1.7 Na₂O, 0.06-0.10 P₂O₅, 4.5-6.3 PbO, 0.5-0.7 SO₂, 0.3-0.6 SiO₂, 0.06-0.10% SnO and 55.0-61.0% ZnO. The second type of toxic waste was a magnesium rich waste including at least 96% by weight magnesium. The third type of toxic waste was contaminated calcium oxide from the scrubbers of the smelter. It was reported that the smelter produced, during regular operation, the three types of waste in a 10:1:1 weight ratio.

Thirteen different glass precursor mixtures were made by mixing the metal scrap waste, the second coal fly ash, the toxic scrubber waste and the magnesium rich waste in ratios (waste/ash/scrubber waste/Mg) of 50:50:0:0, 45:55:0:0, 40:60:0:0, 35:65:0:0, 30:70:0:0, 25:75:0:0, 20:80:0:0, 50:50:10:0, 20:80:10:0, 50:50:0:10, 20:80:0:10, 50:50:10:10 and 20:80:10:10.

1 kg of each one of the mixtures was melted and heated to a temperature of between 1350° C. and 1450° C. for about three hours in a Nabertherm HT 12/17 Chamber Furnace (Nabertherm GmbH, Bremen Germany). It was found that both the toxic CaO and the magnesium-rich waste acted as fluxing agents, lowering the vitrification temperature by up to 50° C.

In some cases, the molten glass was granulated in water. The resulting black glassy granulate was found to be a suitable pavement material or for safe disposal by burial.

In other cases, the molten glass mixture was cast as a 20 cm×20 cm plate and devitrified in a two-stage regime. To form nucleation centers, the mixture was cooled at a rate of 60° C./h to and maintained for two hours at a temperature of 800° C. Subsequently, the mixture was heated at a rate of 60° C./h to and maintained for two hours at a temperature of 1100° C. The resulting glass-ceramic plates had a thin dispersed pattern of gray, light brown, dark brown and black structures.

Importantly, in all cases, the total weight-loss of the glass precursor mixtures to form the glass-ceramic was no greater than approximately 10% of the total combined weight, indicating that gas-forming compounds such as halogens, sulfur compounds and phosphorous compounds were reduced and not released into the atmosphere.

Disposal of Municipal Waste Incinerator Residue

Municipal waste incinerator residue (MWIR) was supplied by the city of Ashkelon. Analysis of the waste indicated that the MWIR was composed of up to 62% Fe₂O₃, up to 23% Al₂O₃, up to 7% MgO, up to 2.2% Na₂O, up to 5% K₂O, up to 1% MnO₂, up to 0.2% Cr₂O₃, up to 0.3% B₂O₃, up to 0.2% ZnO, and up to 0.1% CuO as well as a total of 0.4% Li, V, Co, Ni, Sn, W and Pb.

Five different glass precursor mixtures were made by mixing the MWIR with the first coal fly ash in ratios (waste/ash) of 34:66, 32:68, 30:70, 28:72 and 25:75.

1 kg of each one of the glass precursor mixtures was melted and heated to a temperature of about 1500° C. for up to about two hours in a Nabertherm HT 12/17 Chamber Furnace (Nabertherm GmbH, Bremen Germany).

Each mixture was cast as a 20 cm×20 cm plate and devitrified in a two-stage regime. To form nucleation centers, the mixture was cooled at a rate of 60° C./h to and maintained for two hours at a temperature of 900° C. Subsequently, the mixture was heated at a rate of 60° C./h to and maintained for two hours at a temperature of 1100° C.

The resulting glass-ceramic plates had a very beautiful thin dispersed pattern of light green and dark green structures. The plates all had mechanical properties suitable for use as flooring tiles.

Importantly, in all cases, the total weight-loss of the glass precursor mixtures to form the glass-ceramic was no greater than approximately 8% of the total combined weight, indicating that gas-forming compounds such as halogens, sulfur compounds and phosphorous compounds were reduced and not released into the atmosphere.

Disposal of Batteries

1 kg of assorted discarded batteries is mixed with 9 kg of the second coal fly ash. The battery/ash mixture is heated to a temperature of about 1500° C. for up to about two hours in a gas-fired glass-melting furnace. The molten mixture is cast as 20cm×20 cm plated and devitrified in a two-stage regime as described above.

Generally, the nomenclature used herein and the laboratory procedures utilized in the present invention include techniques from the fields of biology, chemistry and engineering. Such techniques are thoroughly explained in the literature.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, the present invention is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A method for using coal ash comprising:
a) providing a molten glass composition including a first amount of coal ash and a second amount of a mineral waste;
b) maintaining said molten glass composition in a molten state for a period of time so as to reduce components of said glass-precursor composition; and
c) solidifying said molten glass composition so as to obtain a solid material

2. The method of claim 1, wherein providing a molten glass composition includes:
i) mixing said coal ash with said mineral waste to obtain a glass-precursor composition; and
ii) melting said glass-precursor composition to obtain said molten glass composition.

3. The method of claim 1, wherein said molten glass composition includes a reducing agent.

4. The method of claim 1, wherein said reducing agent is carbon.

5. The method of claim 3, wherein said carbon is a carbon component of said mineral waste.

6. The method of claim 4, wherein said carbon is a carbon component of said coal ash.

7. The method of claim 5, wherein said carbon component of said coal ash is greater than about 0.5% by weight of said coal ash.

8. The method of claim 5, wherein said carbon component of said coal ash is greater than about 1% by weight of said coal ash.

9. The method of claim 5, wherein said carbon component of said coal ash is greater than about 5% by weight of said coal ash.

10. The method of claim 5, wherein said carbon component of said coal ash is greater than about 10% by weight of said coal ash.

11. The method of claim 1, wherein said coal ash comprises coal fly ash.

12. The method of claim 1, wherein said coal ash comprises coal bottom ash.

13. The method of claim 1, wherein said coal ash comprises between about 30% and about 75% by carbonless weight SiO₂.

14. The method of claim 1, wherein said coal ash comprises between about 40% and about 71% by carbonless weight SiO₂.

15. The method of claim 1, wherein said coal ash comprises between about 10% and about 40% by carbonless weight Al₂O₃.

16. The method of claim 1, wherein said coal ash comprises between about 15% and about 35% by carbonless weight Al₂O₃.

17. The method of claim 1, wherein said coal ash comprises between about 2% and about 20% by carbonless weight Fe₂O₃.

18. The method of claim 1, wherein said coal ash comprises between about 3% and about 16% by carbonless weight Fe₂O₃.

19. The method of claim 1, wherein said mineral waste comprises a waste selected from the group of wastes consisting of aluminum dross, asbestos, auto shredder residue, batteries, blast furnace slag, cement waste, coal mine schist, contaminated soils, demolition waste, electric arc furnace dust, electroplating waste, flue gas desulfurization waste, geological mine tailings, heavy metal waste, health care incinerator waste, incinerator ash, inorganic filter media, ion-exchange resins, lead slag, municipal waste incinerator residue, paint waste, paper ash, photographic waste, red waste, rubber waste, scrubber waste, sewage sludge ash, scrap metal waste, sludge solids, solid residue of aqueous waste streams, spent filter aids, steel slag, tile dust, urban waste, varnish sludge, zeolites, zinc slag and mixtures thereof.

20. The method of claim 1, wherein said mineral waste is substantially a waste selected from the group of wastes consisting of aluminum dross, asbestos, auto shredder residue, batteries, blast furnace slag, cement waste, coal mine schist, contaminated soils, demolition waste, electric arc furnace dust, electroplating waste, flue gas desulfurization waste, geological mine tailings, heavy metal waste, health care incinerator waste, incinerator ash, inorganic filter media, ion-exchange resins, lead slag, municipal waste incinerator residue, paint waste, paper ash, photographic waste, red waste, rubber waste, scrubber waste, sewage sludge ash, scrap metal waste, sludge solids, solid residue of aqueous waste streams, spent filter aids, steel slag, tile dust, urban waste, varnish sludge, zeolites, zinc slag and mixtures thereof.

21. The method of claim 1, wherein said mineral waste comprises more than about 2% by weight gas-forming components.

22. The method of claim 21, wherein said mineral waste comprises more than about 4% by weight gas-forming components.

23. The method of claim 21, wherein said mineral waste comprises more than about 6% by weight gas-forming components.

24. The method of claim 21, wherein said mineral waste comprises more than about 10% by weight gas-forming components.

25. The method of claim 21, wherein said mineral waste comprises more than about 20% by weight gas-forming components.

26. The method of claim 21, wherein said gas-forming components are components including at least one atom selected from the group consisting of phosphorous, sulfur and a halogen.

27. The method of claim 1, wherein said first amount is more than about 30% by weight of said second amount.

28. The method of claim 1, wherein said first amount is more than about 50% by weight of said second amount.

29. The method of claim 1, wherein said first amount is more than about 80% by weight of said second amount.

30. The method of claim 1, wherein said first amount is more than about 100% by weight of said second amount.

31. The method of claim 1, wherein said first amount is more than about 150% by weight of said second amount.

32. The method of claim 1, further comprising, adding a fluxing agent to obtain said glass precursor composition.

33. The method of claim 32, wherein said fluxing agent is a waste material.

34. The method of claim 1, wherein during said maintaining, the temperature of said molten glass composition is higher than about 1200° C.

35. The method of claim 1, wherein during said maintaining, the temperature of said molten glass composition is higher than about 1250° C.

36. The method of claim 1, wherein during said maintaining, the temperature of said molten glass composition is higher than about 1300° C.

37. The method of claim 1, wherein during said maintaining, the temperature of said molten glass composition is higher than about 1350° C.

38. The method of claim 1, wherein during said maintaining, the temperature of said molten glass composition is less than about 1600° C.

39. The method of claim 1, wherein during said maintaining, the temperature of said molten glass composition is less than about 1500° C.

40. The method of claim 1, wherein said period of time is longer than about 1 hour.

41. The method of claim 1, wherein said period of time is longer than about 2 hours.

42. The method of claim 1, wherein said period of time is longer than about 3 hours.

43. The method of claim 1, wherein said solidifying includes cooling said molten glass composition so that said solid material obtained is a glass.

44. The method of claim 43, further comprising an action comprising an action from the group consisting of casting, rolling, blowing, pressing and drawing said glass.

45. The method of claim 1, wherein said solidifying includes devitrification of said molten glass composition.

46. The method of claim 45 wherein said devitrification includes maintaining said molten glass composition in a molten state for a period of time sufficient to allow crystallization of at least some of said molten glass composition.

47. The method of claim 45, wherein said solidifying includes devitrifying said molten glass composition so that said solid material obtained is a marble-like glass.

48. The method of claim 45, wherein said solidifying includes devitrifying said molten glass composition so that said solid material obtained is a glass-ceramic.

49. A solid material, substantially produced according to the method of claim 1.

50. An article, comprising a solid material made according to the method of claim 1.

51. The article of claim 50, wherein said solid material is a glass.

52. The article of claim 50, wherein said solid material is a glass-ceramic.

53. The article of claim 50, wherein said solid material is a marble-like glass.

54. The use of scrubber waste as a fluxing agent.

55. The use of scrubber waste as a fluxing agent in the production of glass.
